(19) United States
(12) Patent Application Publication
(10) Pub. No.: US 2019/0175445 A1
(43) Pub. Date: Jun. 13, 2019

(54) POOL WITH MASSAGE AND AUDIO PLAYING CAPABILITIES

(71) Applicant: INTEX INDUSTRIES XIAMEN CO. LTD., Haicang, Xiamen, Fujian (CN)

(72) Inventors: Yaw Yuan HSU, Haicang, Xiamen, Fujian (CN); Huang Hsiang LIN, Haicang, Xiamen, Fujian (CN)

(73) Assignee: Intex Industries Xiamen Co. Ltd., Haicang, Xiamen, Fujian (CN)

(21) Appl. No.: 16/302,540

(22) PCT Filed: May 18, 2017
(86) PCT No.: PCT/IB2017/052949

§ 371 Date: Nov. 16, 2018

(30) Foreign Application Priority Data
May 18, 2016 (CN) 201620453114.6
May 18, 2016 (CN) 201620455231.6

(51) Int. Cl. A61H 33/02; E04H 4/00; E04H 4/12; H04R 1/02

(52) U.S. Cl. CPC A61H 33/02; E04H 4/0025; E04H 4/12; H04R 1/028; H04R 2420/07; A61H 2201/0103; A61H 2201/0157; A61H 2201/5097; H04R 1/025

(57) ABSTRACT

A spa (100) having massage and an audio playing capabilities is provided. The spa (100) comprises a processor (206), a wireless communication module (234), an audio playing module (236) and an audio output device (232). The audio output device (232) outputs the audio signal in an audible manner to a user.

### CROSS REFERENCE TO RELATED APPLICATIONS

This application claims priority to the following Chinese patent applications, the disclosures of which are hereby expressly incorporated by reference herein in their entirety:

| Application No. | Filing Date |
|---|---|
| CN 201620455231.6 | May 18, 2016 |
| CN 201620453114.6 | May 18, 2016 |

### FIELD OF THE DISCLOSURE

The present disclosure relates to a pool having various feature, and more particularly, a spa having the capability to play audio.

### BACKGROUND OF THE DISCLOSURE

Pools and spas are popular among users for relaxation purposes. Some pools and spas have massage capabilities which can enhance relaxation for the user. However, such pools and spas can lack additional features that could further enhance the experience of the user. As such, a pool or spa that has audio playing capabilities is desired for the purposes of enhancing the user's physical and mental relaxation when in the pool.

### SUMMARY

The present disclosure provides a pool or spa having massage and audio playing capabilities. The pool/spa's audio playing capabilities are controlled by an audio control module that reads incoming audio data and outputs audio that can be heard by the user. As such, the pool/spa can provide both massage and audio functionalities to a user depending on the user's preferences.

According to an embodiment of the present disclosure, an inflatable spa is provided. The inflatable spa includes an external wall, an internal wall, a top wall, and a bottom wall cooperating to define an inflatable air chamber and a water cavity, a processor operably coupled to the spa and configured to control at least one aspect of the water cavity of the spa, a wireless communication module operably coupled to the processor and configured to receive a digital audio signal, an audio playing module operably coupled to the processor and configured to convert the digital audio signal into an analog audio signal, and an audio output device configured to output the analog audio signal in an audible manner to a user.

According to another embodiment of the present disclosure, an inflatable spa includes an external wall, an internal wall, a top wall, and a bottom wall cooperating to define an inflatable air chamber and a water cavity, a processor operably coupled to the spa and configured to control at least one aspect of the water cavity of the spa, a wireless communication module operably coupled to the processor, a digital input port, an analog input port, an audio playing module operably coupled to the wireless communication module, the digital input port, and the analog input port to receive an audio signal, wherein each of the wireless communication module, the digital input port, and the analog input port is configured to receive the audio signal, and an audio output device configured to output the audio signal in an audible manner to a user.

According to yet another embodiment of the present disclosure, an inflatable spa includes an external wall, an internal wall, a top wall, and a bottom wall cooperating to define an inflatable air chamber and a water cavity, a processor, a water pump operably coupled to the processor, a first water pipe that extends from the water cavity, through the inflatable air chamber, and to the water pump, a second water pipe that extends from the water pump, through the inflatable air chamber, and to the water cavity, an air pump operably coupled to the processor, an air pipe that extends from the air pump, through the inflatable air chamber, and to the water cavity, a wireless communication module operably coupled to the processor and configured to receive an audio signal, and an audio output device operably coupled to the processor and configured to output the audio signal in an audible manner to a user.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a perspective view an inflatable spa coupled to a processing module having a control panel for controlling operation of the spa;

FIG. 2 is a schematic block diagram of a processing module having wireless control functionality and a control panel in accordance with the present disclosure;

FIG. 3 is another schematic block diagram of a processing module and a control panel having wireless control functionality in accordance with the present disclosure;

FIG. 4 is another schematic block diagram of a processing module having wireless control functionality and additional audio capabilities and a control panel in accordance with the present disclosure; and

FIG. 5 is a schematic block diagram of a control panel having wireless functionality configurable for use in the system of FIG. 4.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

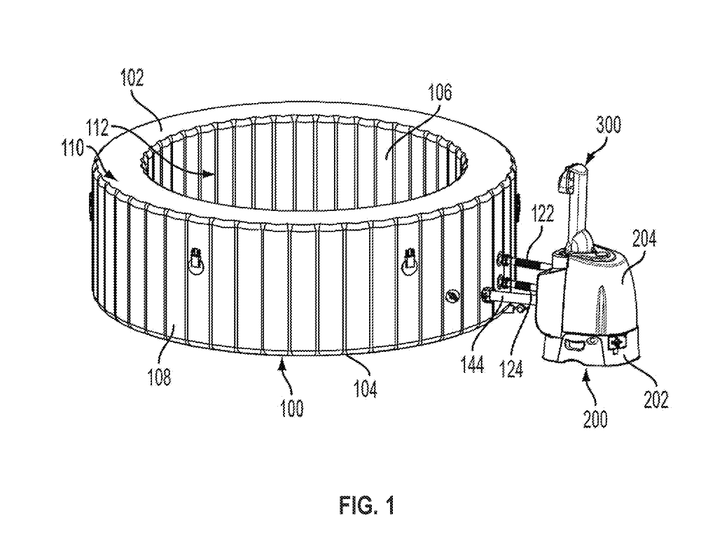

Referring initially to FIG. 1, an inflatable pool or spa 100 is shown including a top wall 102, a bottom wall 104, an internal wall 106, and an external wall 108. Walls 102, 104, 106, and 108 of spa 100 may be constructed of polyvinyl chloride (PVC), thermoplastic rubber (TPR), ethylene vinyl acetate (EVA), thermoplastic polyurethane elastomer (TPU), or other suitable materials. Walls 102, 104, 106, and 108 of the illustrative spa 100 cooperate to define an inflatable air chamber 110, which may be inflated for use and deflated for storage. Also, walls 104 and 106 of the illustrative spa 100 cooperate to define a water cavity 112 for bathing and/or swimming.

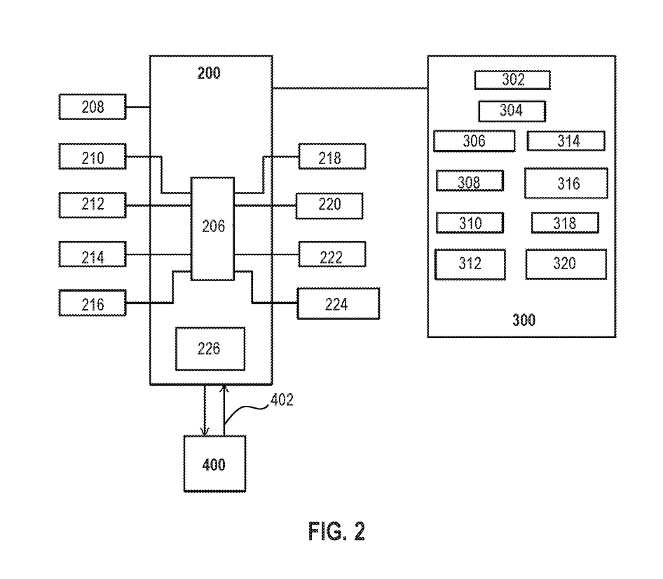

Spa 100 is coupled to a control system or processing module 200. More specifically, the illustrative spa 100 of FIG. 1 is coupled to processing module 200 via a first water pipe 122 that directs water from water cavity 112 of spa 100, through inflatable chamber 110, and to processing module 200, a second water pipe 124 that returns water from processing module 200, through inflatable chamber 110, and to water cavity 112 of spa 100, and an air pipe 144 that directs air from processing module 200, through inflatable chamber 110, and into water cavity 112 of spa 100 in the form of air bubbles. It is also within the scope of the present disclosure that processing module 200 may direct one or more jetted water streams into spa 100. The air that is directed into spa 100 may serve a massaging function for the user. The illustrative processing module 200 has a base 202, an outer shell 204 mounted to base 202, and an internal processor 206 (FIG. 2). The illustrative processing module 200 also communicates with a control panel 300. In use, the operation of spa 100 is controlled by inputting user commands into control panel 300, which sends appropriate signals to processor 206 (FIG. 2) of processing module 200. The illustrative control panel 300 of FIG. 1 is spaced apart from the spa 100 and extends upward from processing module 200 to facilitate user access from inside the spa 100. In other embodiments, control panel 300 may be located directly on at least one of top wall 102, internal wall 106, or external wall 108 of spa 100, for example.

Additional information regarding spa 100 and processing module 200 is disclosed in U.S. Pat. No. 9,254,240 titled “Inflatable Spa,” the disclosure of which is hereby expressly incorporated by reference herein in its entirety.

Processing module 200 and control panel 300 are described in more detail with reference to FIGS. 2-5. Generally, processing module 200 and control panel 300 are operably coupled to each other such that a user can adjust settings on control panel 300 to alter various features of spa 100 (FIG. 1) via processing module 200 as discussed in greater detail herein.

Referring now FIG. 2, the illustrative control panel 300 includes a display screen 302 and a plurality of buttons that interact with processor 206 of processing module 200 to adjust the settings of spa 100 (FIG. 1). More specifically, control panel 300 includes a power button 304, an air button 306, a filter button 308, a cooling button 310, an energy-saving button 312, a heating button 314, a temperature conversion button 316, a warming button 318, and a water treatment button 320.

Display screen 302 functions to display information of spa 100 to a user. For example, display screen 302 may show real-time temperature information of spa 100 and/or provide information regarding altering the temperature of spa 100.

Power button 304 toggles power input 208 of processing module 200 between an on configuration where electric power from an external or internal power source (e.g., battery) (not shown) is supplied to processing module 200 via power input 208 and an off configuration where electric power is not supplied to processing module 200. In one exemplary embodiment, when power button 304 and power input 208 are in the off configuration, processing module 200 and its components are unable to function due to lack of the requisite power. In an alternate embodiment, processing module 200 includes a secondary internal power source (e.g., battery) (not shown) such that processing module 200 can still function and power certain desired components of processing module 200 even when power switch 304 and power input 208 are in the off configuration relative to the primary power source.

The function and interaction of the remaining buttons of control panel 300 with corresponding units of processing module 200 are discussed further herein.

The illustrative processing module 200 includes processor 206 and power input 208, which were already discussed above, and a wireless communication module 226, which is discussed in further detail below. Processor 206 is coupled to a water pump 210 having a built-in filter (which may also be referred to as a “filter pump”), an air pump 212, one or more water heaters 214, 216, a temperature fuse 218, a temperature probe 220, a water flow switch 222, and a water treatment system 224. It is contemplated that, in alternate embodiments, other units of spa 100 may be coupled to processor 206 and have corresponding buttons on control panel 300.

Water pump 210 and water treatment system 224 communicate with water cavity 112 of spa 100. More specifically, water pump 210 and water treatment system 224 receive water from water cavity 112 of spa 100 via first water pipe 122 (FIG. 1), then treat the water by filtering and softening the entering water, and then return the treated water to water cavity 112 of spa 100 via second water pipe 124 (FIG. 1). In exemplary embodiments, the filter of water pump 210 may be a sand filter, a diatomaceous earth filter, or a cartridge filter. The user may selectively activate and deactivate water pump 210 and water treatment system 224 of processing module 200 using filter button 308 and water treatment button 310 on the control panel 300, respectively. It is also within the scope of the present disclosure that some units may activate and deactivate automatically based on the status of another unit. For example, whenever heating units 214, 216 are activated, water pump 210 may activate automatically to supply filtered water therethrough. As another example, whenever water pump 210 is activated, water treatment system 224 may activate automatically to further treat the filtered water.

Air pump 212 communicates with water cavity 112 of spa 100 and is configured to direct air into spa 100 via air pipe 144 (FIG. 1) to form massaging air bubbles within spa 100. The user may selectively activate and deactivate air pump 212 using air button 306. In certain embodiments, the speed or other operating parameters of air pump 212 may also be adjusted to control the rate and/or amount of air bubbles supplied to spa 100. Thus, if a user desires that more bubbling is needed within spa 100, the operating parameters of pump 212 may be adjusted via air button 306 to increase air input into spa 100. It is also within the scope of the present disclosure that air pump 212 may activate and deactivate automatically based on the status of another unit. Rather than being coupled to water cavity 112 of spa 100 via air pipe 144 (FIG. 1), air pump 212 may be placed in communication with air chamber 110 to inflate spa 100. In this arrangement, air button 306 may serve as an inflation button for spa 100.

Heating units 214, 216 are in fluid communication with the water cavity 112 of spa 100 and are configured to control the water temperature within spa 100 by adding heat to incoming water streams. More specifically, heating units 214, 216 receive water from water cavity 112 of spa 100 via first water pipe 122 (FIG. 1), heat the water (if applicable), and then return the water to water cavity 112 of spa 100 via second water pipe 124 (FIG. 1). This heating may be performed based on user input on control panel 300. Heating button 314 can be actuated to activate at least one of heating units 214, 216. Additionally, warming button 318 and cooling button 310 can be actuated to raise or lower a desired temperature set-point for the user, respectively.

Processor 206 is also coupled to temperature probe 220, which operates to measure the actual water temperature within water cavity 112 of spa 100 (FIG. 1). Temperature probe 220 sends the measured or actual water temperature from probe 220 to processor 206 and to control panel 300 where the temperature can be displayed on display screen 302. Display screen 302 may also display the desired temperature set-point from buttons 318, 310. In this way, a user can acquire real-time temperature information of spa 100. The temperature information may be displayed in Fahrenheit (° F.) units or Celsius (° C.) units by pressing temperature conversion button 316.

In operation, if temperature probe 220 determines that the actual water temperature is less than the desired temperature set-point, then processor 206 operates one or both heaters 214, 216 to raise the water temperature within spa 100. Alternatively, if temperature probe 220 determines that the actual water temperature is already above the desired temperature set-point, then thermal fuse 218 may interrupt power to heaters 214, 216, to prevent heaters 214, 216 from applying additional heat to the incoming water streams, thereby reducing the water temperature within spa 100.

To prevent overheating of processing module 200, water flow switch 222 may be provided in fluid communication with the water cavity 112 of spa 100 (FIG. 1). If water flow switch 222 determines that the water flow is too low due to a blockage, leak, or another cause, then water flow switch 222 may interrupt power to heaters 214, 216, or other components of processing module 200.

The energy-saving button 312 of control panel 300 may limit power to one or more components of processing module 200 to conserve energy. For example, pressing the energy-saving button 312 may prevent air pump 212 and water heaters 214, 216, from operating simultaneously.

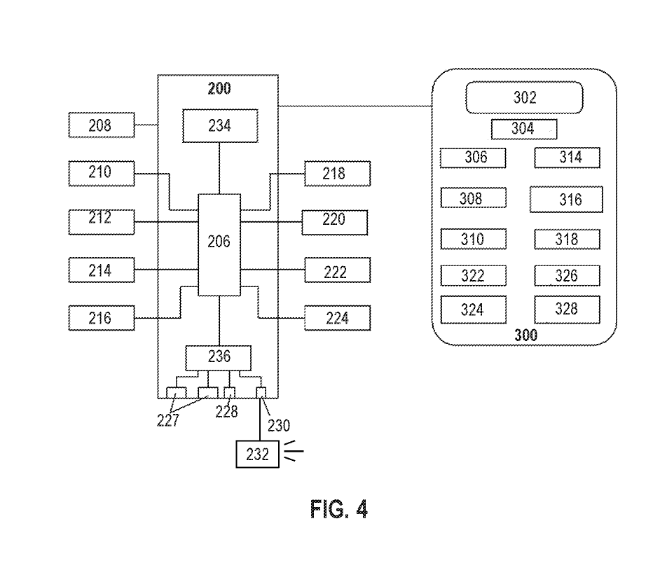

As shown in FIG. 2, processing module 200 further includes a wireless communication (e.g., Bluetooth, WiFi, infrared) module 226, which establishes a wireless connection between processing module 200 and a remote control device 400 having a suitable software program or mobile application installed thereon for operating spa 100 (FIG. 1). According to an exemplary embodiment of the present disclosure, device 400 is a smartphone, tablet, or computer, for example. According to another exemplary embodiment of the present disclosure, device 400 is a dedicated component of spa 100. Processing module 200 is configured to send and/or receive wireless (e.g., Bluetooth, WiFi, infrared) signals 402 to and/or from device 400. Communication module 226 relays signals 402 to processor 206 and/or other corresponding components of processing module 200. For example, after signal 402 is relayed from communication module 226 to processor 206, signal 402 may then be sent to the corresponding units 210-224 based on the contents of signal 402. This configuration enables device 400 to control the settings of spa 100 remotely by communicating wirelessly with processing module 200. For example, the user's device 400 can send wireless signals 402 that contain audio content to the communication module 226, which can then relay the signals 402 to be played to a suitable audio playing module 236 (FIG. 4), as discussed further below. In another example, the user's device 400 can adjust the water temperature within spa 100 by sending the appropriate wireless signal 402 to communication module 226, which can then relay the signals 402 to heaters 214, 216.

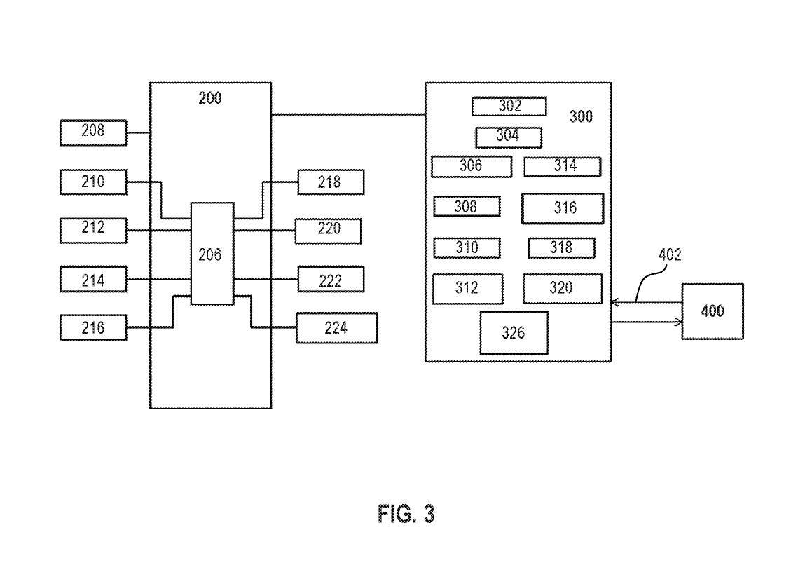

Referring now to FIG. 3, processing module 200 and control panel 300 are substantially the same as the processing module 200 and the control panel 300 of FIG. 2. In the illustrated embodiment however, communication module 326 is included in control panel 300. Like communication module 226 of FIG. 2, communication module 326 of FIG. 3 is coupled to device 400 via a wireless connection between communication module 326 and device 400 and configured to receive and relay signals 402. Signal 402 is then sent from control panel 300 to processing module 200 and the corresponding units 210-224 based on the contents of signal 402. The illustrated configurations of FIGS. 2 and 3 enable device 400 to act as a remote control panel and control the settings of spa 100 by remotely altering operating parameters of spa 100 via processing module 200 and/or control panel 300.

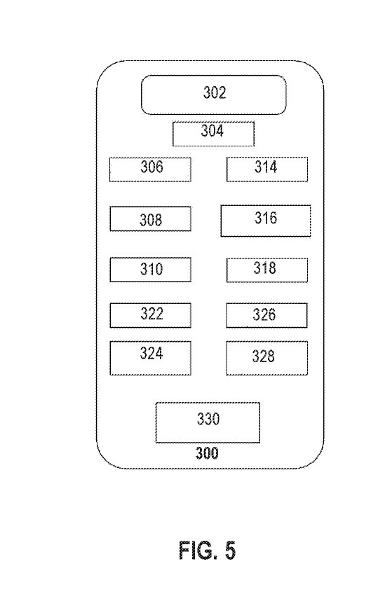

FIGS. 4 and 5 show another embodiment of processing module 200 and control module 300 for spa 100 where processing module 200 and control module 300 include additional units to enable audio functionality within spa 100. As shown in FIG. 4, processing module 200 includes a wireless communication module 234, which operates similar to communication modules 226, 326 of FIGS. 2 and 3. Wireless communication module 234 of FIG. 4 receives wireless (e.g., Bluetooth, WiFi, infrared) signals (similar to signals 402 of FIGS. 2 and 3) and relays the signals to corresponding units of processing module 200 based on the contents of the signal. Wireless communication module 234 allows a user to wirelessly connect an external control device (similar to device 400 of FIGS. 2 and 3) to spa 100 to control various aspects of spa 100, as described above,

In addition to the features described above, processing module 200 of FIG. 4 may include an audio playing module 236 capable of playing audio for the user of spa 100 (FIG. 1). Audio playing module 236 may include a digital-to-analog converter (DAC). When prompted by processor 206, the DAC of the audio playing module 236 may convert digital audio signals into analog audio signals that can be heard by the user via an audio output device 232 (e.g., speaker, headphone set).

In certain embodiments, audio playing module 236 may communicate with wireless communication module 234 to receive wireless audio signals from an external device (similar to device 400 of FIGS. 2 and 3). In this embodiment, device 400 may have an audio program (e.g., iTunes, Pandora, Spotify) installed thereon and configured to access and/or play audio files (e.g., MP3 files). Such wireless audio signals from wireless communication module 234 may be converted to analog audio signals using the DAC of the audio playing module 236.

In other embodiments, audio playing module 236 may communicate with one or more digital input ports 227 (e.g., USB ports) and/or an analog input port 228 (e.g., auxiliary (AUX) cord port). These physical input ports 227, 228 allow the user to physically connect various external audio storage and/or audio playing devices (e.g., USB devices, CD players, cassette players, MP3 players, phones, etc.) to audio playing module 236 to allow for audio play within spa 100. These physical input ports 227, 228 may accommodate audio devices that lack wireless communication (e.g., Bluetooth) capabilities. With respect to digital input ports 227, the incoming digital audio signals may be converted to analog audio signals using the DAC of the audio playing module 236. With respect to the analog input port 228, no conversion may be necessary.

Audio playing module 236 further includes an output port 230 configured to physically receive an adapter plug or audio cable of one or more desired output devices 232 and deliver analog audio signals to the output device 232. This arrangement allows a user to listen to audio via the output device 232 while in spa 100. The location of output device 232 may vary. For example, output device 232 may be coupled to processing module 200, control panel 300, and/or directly to spa 100 with adequate water protection (FIG. 1).

Control panel 300 of FIGS. 4 and 5 is similar to the control panels 300 described above in FIGS. 2 and 3 in that control panel 300 includes a display screen 302, a power switch 304, and a plurality of buttons to control various features of spa 100. Control panel 300 of FIGS. 4 and 5 is operably coupled to processing module 200 such that a user's input into control panel 300 results in processing module 200 adjusting the corresponding units 208-224, 234-236 of spa 100. However, the illustrated control panel 300 of FIGS. 4 and 5 enables a user to control various features of the audio that is played via buttons 322-328. Buttons 322-328 communicate with processor 206 which sends the input from buttons 322-328 to either wireless communication module 234 and/or audio playing module 236.

Control panel 300 includes a mode switch button 326 that operates to toggle the audio playing module 236 between a first mode where audio playing module 236 searches for wireless inputs from wireless communication module 234 and a second mode where audio playing module 236 reads physical data from one or more ports 227, 228. It is contemplated that alternate modes for audio playing module 236 may exist. It is also contemplated that mode switch button 326 also alters various features of the audio that is played (e.g., bass boost, treble boost, etc.).

Play/pause button 322 functions to toggle audio playing module 236 between a play setting where audio files are read, converted into analog audio signals when prompted by processor 206, and transmitted via output device 232 (FIG. 4) and a default, pause setting where audio files are not read, converted, or transmitted by audio playing module 236 via output device 232 (FIG. 4). In an exemplary embodiment, a single actuation of button 322 can toggle audio playing module 236 between a play setting and a pause setting. However, it is contemplated that in alternate embodiments, other actuation patterns of play/pause button 322 may be used to toggle between the pause and play settings.

Volume up/rewind button 324 functions to increase the volume of the audio data being read, converted into analog audio signals when prompted by processor 206, and transmitted by audio playing module 236 via output device 232 (FIG. 4) and to rewind the audio data depending on the actuation duration of button 324. In an exemplary embodiment, a single actuation of button 324 increases the volume of the audio by a single unit and a long-press (e.g., 5 milliseconds or longer) rewinds the audio in 5 second increments until button 324 is no longer pressed/actuated. However, it is contemplated that in alternate embodiments, other actuation/long-press patterns and corresponding volume changes and rewind time increments may be used.

Volume down/fast forward button 328 functions to decrease the volume of the audio data being read, converted into analog audio signals when prompted by processor 206, and transmitted by audio playing module 236 via output device 232 (FIG. 4) and to fast forward the audio data depending on the actuation duration of button 328. In an exemplary embodiment, a single actuation of button 328 decreases the volume of the audio by a single unit and a long-press (e.g., 5 milliseconds or longer) advances the audio in 5 second increments until button 324 is no longer pressed/actuated. However, it is contemplated that in alternate embodiments, other actuation/long-press patterns and corresponding volume changes and advance time increments may be used.

Another embodiment of control panel 300 is shown in FIG. 5 where control panel 300 includes wireless communication module 330, which functions similarly to wireless communication modules 226, 326, 234 of FIGS. 2-4. Wireless communication module 330 is operably coupled to processor 206 and functions to communicate (when activated) with an external device (similar to device 400 of FIGS. 2 and 3) through wireless signals (similar to signals 402 of FIGS. 2 and 3) to operate various features of spa 100 (e.g., audio, temperature, bubbles, etc.).

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An inflatable spa comprising:
an external wall, an internal wall, a top wall, and a bottom wall cooperating to define an inflatable air chamber and a water cavity;
a processor operably coupled to the spa and configured to control at least one aspect of the water cavity of the spa;
a wireless communication module operably coupled to the processor and configured to receive a digital audio signal;
an audio playing module operably coupled to the processor and configured to convert the digital audio signal into an analog audio signal; and
an audio output device configured to output the analog audio signal in an audible manner to a user.

2. The inflatable spa of claim 1, further comprising a control panel operably coupled to the processor, the control panel including:
a display screen configured to display information regarding the spa to the user;
a power switch configured to control power input to the processor; and
a plurality of buttons operably coupled to the processor to control the at least one aspect of the water cavity of the spa.

3. The inflatable spa of claim 1, wherein the processor is operably coupled to at least one of a water filter pump, an air pump, and a heater to control the at least one aspect of the water cavity of the spa.

4. The inflatable spa of claim 3, wherein the plurality of buttons includes:
an air button operably coupled to the air pump;
a filter button operably coupled to the water filter pump; and
a heating button operably coupled to the heater.

5. The inflatable spa of claim 1, wherein the audio playing module is operably coupled to a digital input port and an analog input port.

6. The inflatable spa of claim 5, wherein the audio playing module is configured to receive a digital audio signal from the digital input port and convert the digital audio signal to an analog audio signal for the audio output device.

7. The inflatable spa of claim 1, wherein the wireless communication module is configured to receive the digital audio signal wirelessly from an external device.

8. The inflatable spa of claim 7, wherein the external device is a smartphone.

9. The inflatable spa of claim 1, wherein the audio output device is one of a speaker and a headphone set.

10. An inflatable spa comprising:
an external wall, an internal wall, a top wall, and a bottom wall cooperating to define an inflatable air chamber and a water cavity;
a processor operably coupled to the spa and configured to control at least one aspect of the water cavity of the spa;
a wireless communication module operably coupled to the processor;
a digital input port;
an analog input port;
an audio playing module operably coupled to the wireless communication module, the digital input port, and the analog input port to receive an audio signal, wherein each of the wireless communication module, the digital input port, and the analog input port is configured to receive the audio signal; and
an audio output device configured to output the audio signal in an audible manner to a user.

11. The inflatable spa of claim 10, wherein the audio playing module is configured to convert the audio signal from a digital format to an analog format.

12. The inflatable spa of claim 10, wherein the wireless communication module is configured to receive a user input for controlling at least one aspect of the water cavity of the spa.

13. The inflatable spa of claim 12, wherein the wireless communication module is configured to receive the user input from a smartphone.

14. The inflatable spa of claim 12, wherein the at least one aspect of the water cavity of the spa is the water filtration, the water temperature, or the air bubble content of the water cavity of the spa.

15. The inflatable spa of claim 10, wherein the audio output device is mounted to the spa.

16. The inflatable spa of claim 10, wherein the audio output device is mounted to a control panel that is spaced apart from the spa.

17. The inflatable spa of claim 10, wherein the audio output device is at least one of a speaker and a headphone set.

18. An inflatable spa comprising:
an external wall, an internal wall, a top wall, and a bottom wall cooperating to define an inflatable air chamber and a water cavity;
a processor;
a water pump operably coupled to the processor;
a first water pipe that extends from the water cavity, through the inflatable air chamber, and to the water pump;
a second water pipe that extends from the water pump, through the inflatable air chamber, and to the water cavity;
an air pump operably coupled to the processor;
an air pipe that extends from the air pump, through the inflatable air chamber, and to the water cavity;
a wireless communication module operably coupled to the processor and configured to receive an audio signal; and
an audio output device operably coupled to the processor and configured to output the audio signal in an audible manner to a user.

19. The inflatable spa of claim 18, wherein the processor, the water pump, and the air pump are located in a processing module located external to the exterior wall of the spa.

20. The inflatable spa of claim 19, wherein the wireless communication module is located in the processing module.
